(19) United States
(12) Patent Application Publication
(10) Pub. No.: US 2024/0121759 A1
(43) Pub. Date: Apr. 11, 2024

(54) A NETWORK REPEATER

(71) Applicant: NOKIA SOLUTIONS AND NETWORKS OY, Espoo (FI)

(72) Inventor: Keeth Saliya Jayasinghe LADDU, Espoo (FI)

(21) Appl. No.: 18/276,541

(22) PCT Filed: Feb. 11, 2022
(86) PCT No.: PCT/EP2022/053313

§ 371 Date: Aug. 9, 2023

(30) Foreign Application Priority Data
Feb. 12, 2021 (FI) 20215145

(51) Int. Cl. H04W 72/0446; H04L 1/08; H04W 72/51; H04W 72/543

(52) U.S. Cl. CPC H04W 72/0446; H04L 1/08; H04W 72/51; H04W 72/543

(57) ABSTRACT

An apparatus comprising: means for implementing a first component configured to provide a backhaul connection to a parent node of a network; means for implementing a second component configured to provide a backhaul connection to a child node of a network and/or to an access link to a user equipment (UE); means for receiving a plurality of code blocks (CB) of a transport block (TB) arranged in a first time domain resource allocation from the parent node; means for decoding at least a first subset of code blocks; and means for transmitting at least the first subset of code blocks of the transport block at a second time domain resource allocation to the child node or the UE, wherein the number of code blocks in the first subset is configured to be determined at least based on a processing time for decoding the first set of code blocks or a latency target of the plurality of code blocks of the transport block or channel quality parameters of the link.

### TECHNICAL FIELD

The present invention relates to the field of wireless communications and, more particularly, to a repeater node in a network.

### BACKGROUND

Coverage is a fundamental aspect of cellular network deployments. New types of network nodes have been considered to increase mobile operators' flexibility for their network deployments. The 3GPP NR Rel-16 for 5^{th} Generation (5G) has introduced a new type of network node not requiring a wired backhaul referred to as Integrated Access and Backhaul (IAB) node. IAB network in Rel-16 is mainly based on decode-and-forward (DF) relaying concept, and it also supports concatenated relaying where the backhaul can be carried over multiple hops from IAB node to another until the last node serving the access user equipment (UEs).

Another type of network node that can be used for the densification of the cells is a RF (smart) repeater. In general, RF repeaters (or Radio repeaters or RAN repeaters) provide a way of extending range for radio signals, for example in radio access networks (RAN). In its simplest form, a radio repeater is an apparatus that comprises a radio receiver, an amplifier and a radio transmitter. The radio receiver may receive a signal from, for example, a first node of a radio network and may retransmit the signal to another node. The term “relay” may often be used in the same context. RF repeaters have been used in 2G, 3G and 4G/LTE (Long Term Evolution) for deployments to supplement the coverage provided by regular full-stack cells with various transmission power characteristics. They constitute the simplest and most cost-effective way to improve network coverage. RF repeaters are non-regenerative type of relay nodes and they simply amplify-and-forward (AF) everything that they receive.

However, the AF-based repeaters, while being straightforward in easily forwarding the data and reducing the processing delay, they involve the problem that the noise in the channel is amplified, as well, and therefore they may not be the best solution in all channel conditions. The DF-based repeaters, such as the IAB nodes, while enabling to mitigate the noise through the decode and regenerate process, they are associated latency concerns due to the processing delay.

### SUMMARY

Now, an improved method and technical equipment implementing the method has been invented, by which the above problems are alleviated. Various aspects include a method, an apparatus and a non-transitory computer readable medium comprising a computer program, or a signal stored therein, which are characterized by what is stated in the independent claims. Various details of the embodiments are disclosed in the dependent claims and in the corresponding images and description.

The scope of protection sought for various embodiments of the invention is set out by the independent claims. The embodiments and features, if any, described in this specification that do not fall under the scope of the independent claims are to be interpreted as examples useful for understanding various embodiments of the invention.

According to a first aspect, there is provided an apparatus comprising at least one processor and at least one memory, the apparatus being configured to receive a plurality of code blocks of a transport block arranged in a first time domain resource allocation from a parent node; decode at least a first subset of code blocks; and transmit at least the first subset of code blocks of the transport block at a second time domain resource allocation to a child node or a user equipment, wherein the number of code blocks in the first subset is determined at least based on a processing time for decoding the first set of code blocks or a latency target of the plurality of code blocks of a transport block or channel quality parameters of a link.

According to an embodiment, the apparatus is configured to amplify at least a second subset of code blocks; and transmit at least the amplified second subset of code blocks of the transport block at the second time domain resource allocation prior to the first subset of code blocks.

According to an embodiment, the apparatus is configured to indicate an order of at least the first and the second subset of code blocks of the transport block at the second time domain resource allocation and the number of code blocks within the first and the second subset of code blocks to the child node or the user equipment.

According to an embodiment, the apparatus is configured to divide the plurality of code blocks of the transport block arranged in the first time domain resource allocation into a plurality of subsets of code blocks; decode each of the subsets of code blocks; and configured to arrange the subsets of code blocks at the second time domain resource allocation in the same temporal order as received in the first time domain resource allocation.

According to an embodiment, each subset of code blocks comprises only one code block.

According to an embodiment, the apparatus is configured to performing error check for each code block after decoding.

According to an embodiment, the apparatus is configured, in response to detecting an error in at least one code block, to cancel the transmission of remaining code blocks to the child node or the user equipment.

According to an embodiment, the apparatus is configured to request a re-transmission of the transport block or a subset of code blocks containing an error in at least one code block from the parent node.

According to an embodiment, the apparatus is configured, in response to detecting an error in at least one code block after sending control information about the subsets of code block to the child node or the user equipment, to transmit all remaining code blocks to the child node or the user equipment.

According to an embodiment, the apparatus is configured to request a re-transmission of at least the code block containing an error; indicate the error to the child node or the user equipment; and re-transmit at least the code block previously containing an error after correctly receiving said code block from the parent node.

According to an embodiment, the apparatus is configured, in response to detecting an error in at least one code block after sending control information about the subsets of code block to the child node or the user equipment, to seize to transmit any subsequent code blocks of the second transport block to the child node or the user equipment.

According to an embodiment, the apparatus is configured to receive, from the parent node, control information relating at least to size of the transport block and parameters enabling to perform amplifying and/or decoding of the code blocks.

According to an embodiment, the apparatus is configured to send the transport block to the child node or the user equipment as having the same size and comprising the same parameters as received from the parent node.

According to an embodiment, the apparatus is configured to adjust the number of code blocks to be included in the first subset of code block according to the processing capability of the apparatus.

A method according to a second aspect comprises receiving a plurality of code blocks of a transport block arranged in a first time domain resource allocation from a parent node; decoding at least a first subset of code blocks; and transmitting at least the first subset of code blocks of the transport block at a second time domain resource allocation to a child node or a UE, wherein the number of code blocks in the first subset is determined at least based on a processing time for decoding the first set of code blocks or a latency target of the plurality of code blocks of a transport block or channel quality parameters of a link.

Computer readable storage media according to further aspects comprise code for use by an apparatus, which when executed by a processor, causes the apparatus to perform the above methods.

### BRIEF DESCRIPTION OF THE DRAWINGS

For a more complete understanding of the example embodiments, reference is now made to the following descriptions taken in connection with the accompanying drawings in which:

FIG. 1 shows a part of an exemplifying radio access network;

FIG. 2 illustrates an example of IAB node concept;

FIG. 3 illustrates an example of latency generation due to decode/encode process in an IAB node;

FIG. 4 shows a flow chart of a method according to an embodiment;

FIG. 5 shows an example of a combined AF and DF relay approach according to an embodiment;

FIG. 6 shows an example of a DF relay approach according to an embodiment;

FIG. 7 shows an example of handling an error situation in a DF relay approach according to an embodiment;

FIG. 8 shows another example of handling an error situation in a DF relay approach according to an embodiment;

FIG. 9 illustrates an exemplary flow chart of a repeater scheduling in accordance with at least some embodiments; and

FIG. 10 illustrates an exemplary flow chart of a repeater scheduling in accordance with at least some embodiments.

### DETAILED DESCRIPTION OF SOME EXAMPLE EMBODIMENTS

The following describes in further detail suitable apparatus and possible mechanisms for implementing relaying in a repeater. While the following focuses on 5G networks, the embodiments as described further below are by no means limited to be implemented in said networks only, but they are applicable in any network incorporating relay repeaters.

In the following, different exemplifying embodiments will be described using, as an example of an access architecture to which the embodiments may be applied, a radio access architecture based on Long Term Evolution Advanced (LTE Advanced, LTE-A) or new radio (NR, 5G), without restricting the embodiments to such an architecture, however. A person skilled in the art appreciates that the embodiments may also be applied to other kinds of communications networks having suitable means by adjusting parameters and procedures appropriately. Some examples of other options for suitable systems are the universal mobile telecommunications system (UNITS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet protocol multimedia subsystems (IMS) or any combination thereof. The communication network or the radio access architecture may also be a future network or architecture, being planned and/or specified, such as so called 6G network/radio access architecture.

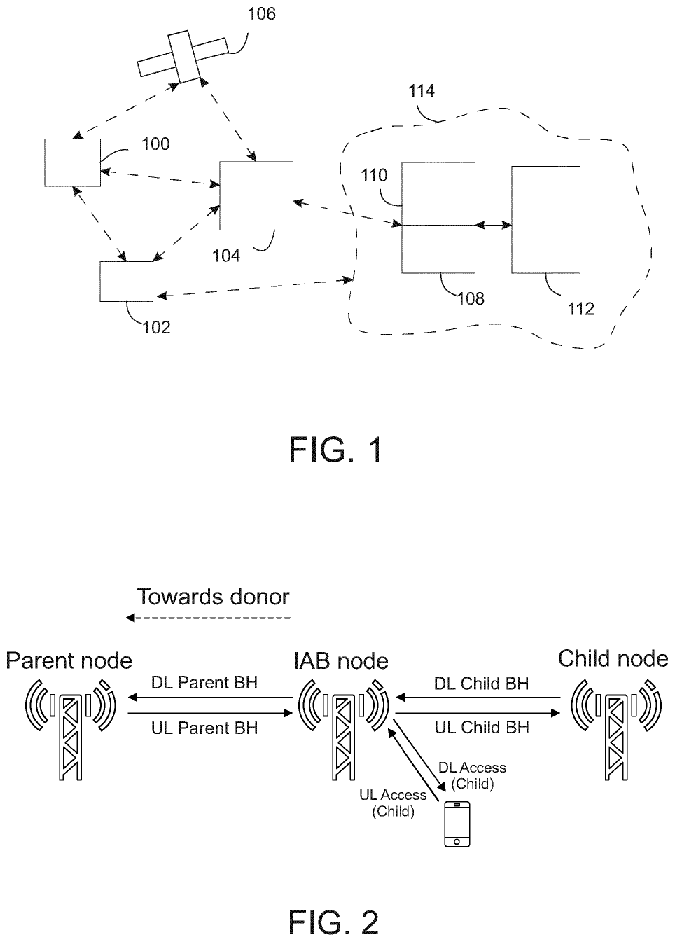

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1. The embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a cell with an access node (such as (e/g)NodeB) 104 providing the cell. The physical link from a user device to a (e/g)NodeB is called uplink or reverse link and the physical link from the (e/g)NodeB to the user device is called downlink or forward link. It should be appreciated that (e/g)NodeBs or their functionalities may be implemented by using any node, host, server or access point etc. entity suitable for such a usage.

A communication system typically comprises more than one (e/g)NodeB in which case the (e/g)NodeBs may also be configured to communicate with one another over links, wired or wireless, designed for the purpose. These links may be used for signaling purposes. The (e/g)NodeB is a computing device configured to control the radio resources of communication system it is coupled to. The NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g)NodeB is further connected to core network 110 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc. The CN may comprise network entities or nodes that may be referred to management entities. Examples of the network entities comprise at least an Access and Mobility Management Function (AMF).

The user device, also called a user equipment (UE), a user terminal, a terminal device, a wireless device, a mobile station (MS) etc., illustrates one type of an apparatus to which resources on the air interface are allocated and assigned, and thus any feature described herein with a user device may be implemented with a corresponding network apparatus, such as a relay node, an eNB, and an gNB. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction. Accordingly, the user device may be an IoT-device. The user device may also utilize cloud. In some applications, a user device may comprise a small portable device with radio parts (such as a watch, earphones or eyeglasses) and the computation is carried out in the cloud. The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input—multiple output (MIMO) antennas, many more base stations or nodes than the LTE (a so-called small cell concept), including macro sites operating in co-operation with smaller stations and employing a variety of radio technologies depending on service needs, use cases and/or spectrum available. The access nodes of the radio network form transmission/reception (TX/Rx) points (TRPs), and the UEs are expected to access networks of at least partly overlapping multi-TRPs, such as macro-cells, small cells, pico-cells, femto-cells, remote radio heads, relay nodes, etc. The access nodes may be provided with Massive MIMO antennas, i.e. very large antenna array consisting of e.g. tens or hundreds of antenna elements, implemented in a single antenna panel or in a plurality of antenna panels, capable of using a plurality of simultaneous radio beams for communication with the UE. The UEs may be provided with MIMO antennas having an antenna array consisting of plurality of antenna elements a.k.a. patches, implemented in a single antenna panel or in a plurality of antenna panels. Thus, the UE may access one TRP using one beam, one TRP using a plurality of beams, a plurality of TRPs using one (common) beam or a plurality of TRPs using a plurality of beams.

5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 6 GHz, cmWave and mmWave, and also capable of being integrated with existing legacy radio access technologies, such as the LTE. Integration with the LTE may be implemented, at least in the early phase, as a system, where macro coverage is provided by the L′I′E and 5G radio interface access comes from small cells by aggregation to the LTE. In other words, 5G is planned to support both inter-RAT operability (such as LTE-5G) and inter-RI operability (inter-radio interface operability, such as below 6 GHz— cmWave— mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (e.g. in a distributed unit, DU) and non-real time functions being carried out in a centralized manner (e.g. in a centralized unit, CU 108).

It should also be understood that the distribution of labor between core network operations and base station operations may differ from that of the L′I′E or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well. The gNB is a next generation Node B (or, new Node B) supporting the 5G network (i.e., the NR).

5G may also utilize non-terrestrial nodes 106, e.g. access nodes, to enhance or complement the coverage of 5G service, for example by providing backhauling, wireless access to wireless devices, service continuity for machine-to-machine (M2M) communication, service continuity for Internet of Things (IoT) devices, service continuity for passengers on board of vehicles, ensuring service availability for critical communications and/or ensuring service availability for future railway/maritime/aeronautical communications. The non-terrestrial nodes may have fixed positions with respect to the Earth surface or the non-terrestrial nodes may be mobile non-terrestrial nodes that may move with respect to the Earth surface. The non-terrestrial nodes may comprise satellites and/or High Altitude Platforms Stations (HAPSs). Satellite communication may utilize geostationary earth orbit (GEO) satellite systems, but also low earth orbit (LEO) satellite systems, in particular mega-constellations (systems in which hundreds of (nano)satellites are deployed). Each satellite in the mega-constellation may cover several satellite-enabled network entities that create on-ground cells. The on-ground cells may be created through an on-ground relay node 104 or by a gNB located on-ground or in a satellite.

A person skilled in the art appreciates that the depicted system is only an example of a part of a radio access system and in practice, the system may comprise a plurality of (e/g)NodeBs, the user device may have an access to a plurality of radio cells and the system may comprise also other apparatuses, such as physical layer relay nodes or other network elements, etc. At least one of the (e/g)NodeBs or may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells, or so-called small cells. The (e/g)NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

The actual user and control data from network to the UEs is transmitted via downlink physical channels, which in 5G include Physical downlink control channel (PDCCH) which carries the necessary downlink control information (DCI), Physical Downlink Shared Channel (PDSCH), which carries the user data and system information for user, and Physical broadcast channel (PBCH), which carries the necessary system information to enable a UE to access the 5G network.

The user and control data from UE to the network is transmitted via uplink physical channels, which in 5G include Physical Uplink Control Channel (PUCCH), which is used for uplink control information including HARQ feedback acknowledgments, scheduling request, and downlink channel-state information for link adaptation, Physical Uplink Shared Channel (PUSCH), which is used for uplink data transmission, and Physical Random Access Channel (PRACH), which is used by the UE to request connection setup referred to as random access.

Frequency bands for 5G NR are separated into two frequency ranges: Frequency Range 1 (FR1) including sub-6 GHz frequency bands, i.e. bands traditionally used by previous standards, but also new bands extended to cover potential new spectrum offerings from 410 MHz to 7125 MHz, and Frequency Range 2 (FR2) including frequency bands from 24.25 GHz to 52.6 GHz. Thus, FR2 includes the bands in the mmWave range, which due to their shorter range and higher available bandwidth require somewhat different approach in radio resource management compared to bands in the FR1.

Coverage is a fundamental aspect of cellular network deployments. As NR moves to higher frequencies (around and above 4 GHz for FR1 deployments and above 24 GHz for FR2), propagation conditions degrade compared to lower frequencies, thereby causing further coverage challenges. Mobile operators typically try to solve the problem by increasing the densification of cells by including different types of network nodes in their deployments. While the deployment of regular full-stack cells is preferred, it may not be always a possible (e.g., due to non-availability of backhaul) or economically viable option.

As a result, new types of network nodes have been considered to increase mobile operators' flexibility for their network deployments. NR Rel-16 has introduced a new type of network node not requiring a wired backhaul referred to as Integrated Access and Backhaul (IAB). The usage of wireless connection for the backhaul (BH)/fronthaul (FH) eliminates the need for cabling of all sites in the deployed network (which can be very dense), which would dramatically reduce the initial deployment costs. Naturally, wired backhaul connection not an option with moving relays. The only option is to utilize wireless connection for which IAB will provide a feasible basis.

IAB network in Rel-16 is mainly based on decode and forward (DF) relaying concept, and it also supports concatenated relaying where the backhaul can be carried over multiple hops from IAB node to another until the last node serving the access UEs. The serving node providing the BH connection is called a parent node, which can be either a donor node (with wired network connection), or another IAB node. The served IAB node is called a child node. The donor node hosts the centralized unit (CU) for all IAB nodes, i.e. it runs RRC, higher L2 (PDCP) and control functions for the subtending IAB topology. Distributed units (DUs) reside at the donor node as well as at each IAB node. The DU hosts lower L2 protocol layers (RLC, MAC) and the physical (PHY) layer. The CU has two control interfaces to the IAB nodes, namely RRC connection to the IAB-MT and Fl-C to the IAB-DU.

FIG. 2 shows the basic connections between the IAB nodes and access UEs. From the middle IAB node perspective, there will be parent BH links as well as child BH and access links, all for both UL and DL.

As mentioned above, IAB nodes can also be classified as decode and forward (DF) relays, as every packet traversing the link between its donor and the MT component of the IAB node itself has to be properly decoded and re-encoded by the IAB node for transmission to the UE or subsequent IAB hop on the access link. Another type of network node that can be used for the densification of the cells is the RF (smart) repeater. RF repeaters have been used in 2G, 3G and 4G deployments to supplement the coverage provided by regular full-stack cells with various transmission power characteristics. They constitute the simplest and most cost-effective way to improve network coverage. The main advantages of RF repeaters are their low-cost, their ease of deployment and the fact that they do not increase latency. The main disadvantage is that they amplify signal and noise and, hence, may contribute to an increase of interference (pollution) in the system. Within RF repeaters, there are different categories depending on the power characteristics and the amount of spectrum that they are configured to amplify (e.g., single band, multi-band, etc.). RF repeaters are non-regenerative type of relay nodes and they simply amplify-and-forward (AF) everything that they receive.

Thus, it may be concluded that two primary relaying schemes, i.e. amplify and forward (AF) approach and decode and forward (DF) approach are used various studies. In AF, relay terminals are retransmitted with only amplifying instead of decoding and regenerating the transmission from the parent node. Therefore, in AF, relay terminals can easily forward and reduce the processing delay to compare with DF. However, there is a problem that relay terminals amplify its noise in AF and may not the best solution in all channel conditions.

On the other hand, since DF performs to decode and to regenerate the data at the relay terminals, the noise enhancement at the relays can be mitigated. However, DF has associated latency concerns, which may become problematic, for example, in the implementation of an IAB node. Compared to a Donor node, IAB nodes have additional component, MT part, which shall support UE functionality for the BH link.

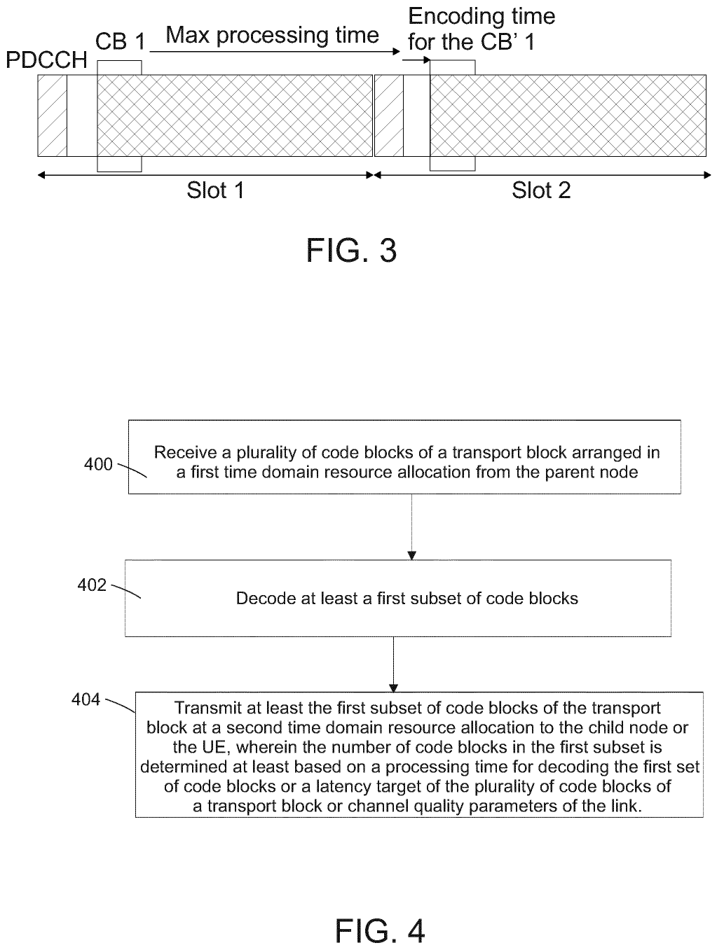

For example, FIG. 3 shows how DL Parent BH link may have both PDCCH and PDSCH transmissions towards a MT part of the IAB node in a first time slot 1. Then, the IAB node has to fully decode the transmissions from the Parent and transmit to the Child node or access UE in the subsequent time slot 2. Given the smaller latency requirements, a fast turnaround from backhaul to access may not be possible due to the IAB processing (physical layer procedure) limitations. For example, at least the following scenarios may lead to the processing capacity of the IAB node to be limited:
A larger transport block size (TBS) support for an access UEs with low latency constraints may require IAB nodes to go through full physical layer procedure (e.g. layer mapping, demodulation, decoding, etc.) for all the code blocks (CBs) with much lower processing times and redo the encoding process to be scheduled in the next slot. However, this actual information is not required at the IAB node.
BH may carry multiple TBs (intended to multiple UEs) within a slot which may require scheduling all or some TBs with latency constraints to be supported in the next slot.
A similar requirement may be required in the UL direction, for example, TBs received by UL Child BH shall be transmitted in UL Parent BH.

Considering the example of slot based BH and access link transmissions shown in FIG. 3, in slot 1 both PDCCH and related PDSCH may be received at the IAB node, and node shall send the same data in the next slot. With Rel-16 IAB architectures, the parent node schedules a transmission and the IAB node decode the packet and schedule as a fresh transmission, the encoding has to wait till decoding of the full TB and higher layer processing. FIG. 3 also illustrates the timing associated with each CB decoding. Prior to sending any of the CBs in the second slot, all the CBs transmitted in slot 1 shall be decoded and checked for TB level CRC and send to upper layer processing and redo the encoding procedures. As some CBs are received at the end of the slot, there will not be enough time to do this process and the most likely scenario is to schedule the data in a later slot than Slot 2, which may not meet the latency requirements.

The problem could be handled by smart repeaters where amplify and forward (AF) relaying can be applied at the node rather than decode and forwarding (DF) used by the traditional TAB nodes. However, full AF relaying may also multiply the noise and interference and packet may not be decodable in some cases.

Consequently, there is a need to provide a faster turnaround at the IAB/smarter repeater nodes such that processing latencies are minimized while maintaining a good performance.

As a first aspect for at least alleviating the above problems, an apparatus is herein introduced, said apparatus comprising: means for implementing a first component configured to provide a backhaul connection to a parent node of a network; means for implementing a second component configured to provide a backhaul connection to a child node of a network and/or to an access link to a user equipment (UE); means for receiving a plurality of code blocks (CB) of a transport block (TB) arranged in a first time domain resource allocation from the parent node; means for decoding at least a first subset of code blocks; and means for transmitting at least the first subset of code blocks of the transport block at a second time domain resource allocation to the child node or the UE, wherein the number of code blocks in the first subset is configured to be determined at least based on a processing time for decoding the first set of code blocks or a latency target of the plurality of code blocks of a transport block or channel quality parameters of the link.

The apparatus may be a network repeater node, such as an IAB or a smart repeater, which receives multiple code blocks (CBs) of a transport block (TB) within the allocated resources e.g. from the parent node in downlink (DL) connection. It is, however, noted that the same principles as described herein apply to uplink (UL) connection, as well, wherein the apparatus receives code blocks (CBs) of a transport block (TB) from a child IAB/access UE.

The apparatus may also be a user apparatus (UE) functioning as a relay or a smart repeater. It is noted that the child node may also be an IAB node, another repeater or a user apparatus (UE).

The apparatus is configured to apply decode and forward approach to at least a subset of code bocks received in a first time domain resource allocation, such as in a first time slot. In order to avoid latency to be generated due to processing delays, the apparatus arranges the decoded, and optionally re-encoded, subset of code blocks of the transport block at a second time domain resource allocation, such as in the second time slot, in such temporal location, which enables the encoding to be completed. Herein, the number of code blocks in the first subset may be determined at least based on a processing time for decoding the first set of code blocks or a latency target of the plurality of code blocks of the transport block or channel quality parameters of the link. Thus, the size of subset of code blocks and/or the temporal distance between the subset of code blocks in the first and the second time domain resource allocation may be adjusted such that the decoding/encoding process does not cause any further latencies.

Another aspect relates to a method implemented in such an apparatus. The method, illustrated by a flow chart of FIG. 4, comprises: receiving (400) a plurality of code blocks (CB) of a transport block (TB) arranged in a first time domain resource allocation from the parent node; decoding (402) at least a first subset of code blocks; and transmitting (404) at least the first subset of code blocks of the transport block at a second time domain resource allocation to the child node or the UE, wherein the number of code blocks in the first subset is determined at least based on a processing time for decoding the first set of code blocks or a latency target of the plurality of code blocks of a transport block or channel quality parameters of the link.

According to an embodiment, the apparatus comprises means for amplifying at least a second subset of code blocks; and means for transmitting at least the amplified second subset of code blocks of the transport block at the second time domain resource allocation prior to the first subset of code blocks.

Accordingly, the code blocks which are received in the first subset of code blocks of the time domain resource allocation are decoded at the network node but the remaining symbols in the second subset of code blocks are only amplified by the network node. For the transmission to the UE/child IAB (or parent node in UL), the amplified symbols in the second subset of code blocks are scheduled in the first part of the time domain resource allocation (i.e., the next time slot) towards the UE/child IAB (or parent node in UL) and decoded CBs in the first subset of code blocks are forwarded on the remaining symbols.

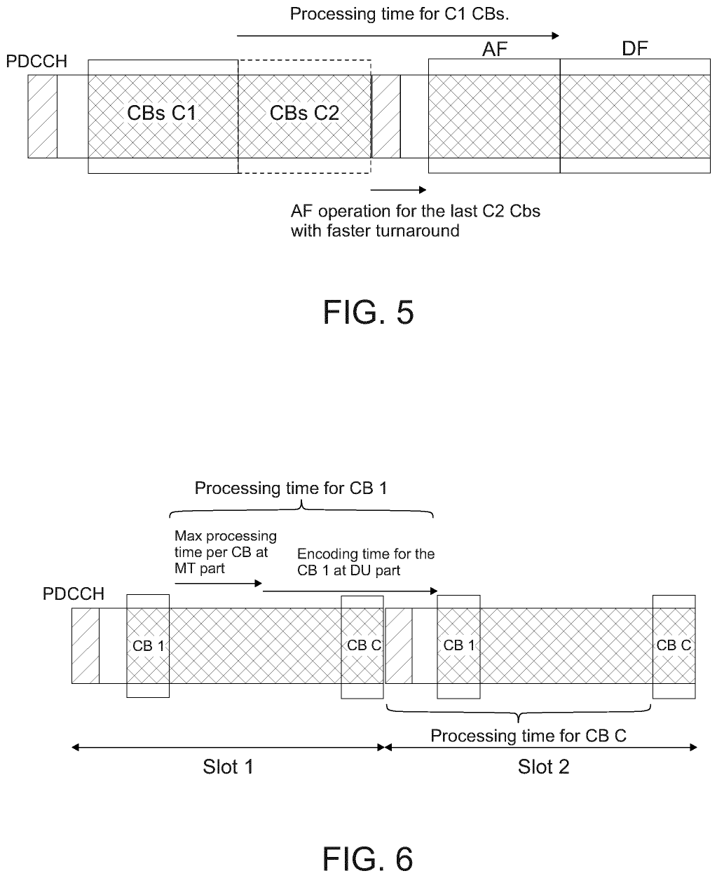

Thus, the temporal order of the first and the second subset of code blocks is changed from the received transport block at first time domain resource allocation to the transport block at second time domain resource allocation to be transmitted towards the UE/child IAB. This is illustrated in FIG. 5, showing first subset of code blocks (CBs in C1) in the beginning of the first time domain resource allocation (first time slot). The first subset of code blocks is followed by the second subset of code blocks (CBs in C2). Now for the second time domain resource allocation (second time slot) to be transmitted towards the UE/child IAB, the second subset of code blocks (CBs in C2) is only amplified and placed in the beginning of the second time domain resource allocation (second time slot). When the TB segmented into more than one CB, the network node can decode the first set of CB(s) after the reception of first symbol(s) and continue just to amplify and forward the remaining symbols. This provides sufficient time for the apparatus to decode and encode the first subset of code blocks (CBs in C1), thereby enabling to reduce the noise relating to the data of the first subset of code blocks.

According to an embodiment, the number of code blocks to be included in the first subset of code block may be adjusted according to the processing capability of the apparatus. Thus, if the number of CBs in a transport block (TB) received at the IAB node is N, then depending on the processing capability of the IAB node, it can decode first M (M<N) CBs and take additional processing timeline for those by just forwarding the last set of CBs (N−M) by amplifying the received signal of the last set of CBs (N−M) and scheduling the amplified CBs at the beginning of the second time domain resource allocation (second time slot), as shown in FIG. 5.

The decision on resources and partition of code blocks for amplify-and-forward (AF) portion and decode-and-forward (DF) portion may be performed at the network node depending on the processing latency. Therein, it may be desirable that symbol level and/or radio block (RB) level splitting is done such that integer number of CBs remain within each partition.

If the partitioning is not providing an integer number of CBs for DF region, for example one portion of the CB is DF region and other in AF region, the portion in the DF may be allocated to AF region and transmitted in the next link.

According to an embodiment, the apparatus is configured not to check for transmission block (TB) level CRC (Cyclic Redundancy Check) when supporting the amplify-and-forward (AF) approach.

Unless additional control signaling is introduced, network node cannot reschedule the DF CBs with a different MCS than what received from the parent node. The parent node may need some CQI feedback of the network node to UE link.

According to an embodiment, the apparatus comprises means for indicating an order of at least the first and the second subset of code blocks within the transport block at the second time domain resource allocation and the number of code blocks within the first and the second subset of code blocks to the child node or the UE.

The network node indicates to the child node/UE about the amplify-and-forward (AF) operation and the number of symbols (or CBs) that are amplified (or decoded), such that the child node/UE can re-order the symbols prior to decoding (or after decoding in case of CBs) to generate desired data and send to upper layers.

It is noted that alternatively or in addition to the network node indicating the child node/UE, it is possible that the parent node or a central unit (CU) configures the child node/UE about the AF operation and a number of symbols (or CBs) that are amplified (or decoded).

According to an embodiment, the apparatus is configured to receive control information relating at least to size of the transport block and parameters enabling to perform amplifying and/or decoding of the code blocks from the parent node.

Hence, the parent node may send control information to the network node regarding the used Modulation and Coding Scheme (MCS), resource allocation, and other control information to determine the transport block size (TBS) and the base graph, in order to schedule data in the child link.

According to an embodiment, the apparatus is configured to send the transport block to the child node or the UE as having the same size and comprising the same parameters as received from the parent node.

The network node may send to the UE, in addition to the indications relating to the amplify forward operation and resource partition information for smart repeating (AF and DF), also the control information received from the parent node, such as regarding the MCS, resource allocation, and other control information to indicate the same TBS and base graph that used in the backhaul transmission.

According to an embodiment, the apparatus comprises means for dividing the plurality of code blocks within the transport block arranged in the first time domain resource allocation into a plurality of subsets of code blocks, wherein said means for decoding are configured to decode each of the subsets of code blocks, and wherein the subsets of code blocks are configured to be arranged at the second time domain resource allocation in the same temporal order as received in the first time domain resource allocation.

Thus, in this embodiment, the amplify-and-forward (AF) approach is not applied, but the plurality of code blocks are divided into a plurality of subsets of code blocks with a suitably small sized subsets such that it provides sufficient time for the apparatus to decode and encode each subset of code blocks and still enable the transmission of the encoded code blocks in the second (subsequent) time slot.

According to an embodiment, each subset of code blocks comprises only one code block. Thus, if necessary, the decoding and encoding may be performed on a code block basis to order to ensure the sufficient processing time. The code block-based decoding and encoding provides the maximum available processing time.

Also with this embodiment, the apparatus may be configured to receive control information relating at least to size of the transport block and parameters enabling to perform amplifying and/or decoding of the code blocks from the parent node. Thus, the parent node may send control information to the network node regarding the used Modulation and Coding Scheme (MCS), resource allocation, and other control information to determine the transport block size (TBS) and the base graph. This information may also be forwarded to to the child node or the UE. Thereby the same number of CBs and size of CB is guaranteed to be exact, and the network node avoids processing on some physical layer parts.

FIG. 6 shows an example of the DF approach described herein. The decoding and encoding are performed on a code block basis, thereby providing the maximum available processing time. The processing time for each code block CB may be conceptually divided in the processing time at the MT part and in the processing time at the DU part. The decoded and encoded first code block CB1 is then placed in beginning of the second time slot for transmission. The subsequent code blocks are decoded and encoded, and the placed in second time slot in the same temporal order as they were in the received first time slot.

According to an embodiment, the apparatus comprises means for performing error check for the subsets of code blocks after decoding. Now when implementing only the DF approach, the apparatus may preferably carry out a TB-level or a code block group (CBG) error check, such as CRC.

According to an embodiment, the apparatus is configured, in response to detecting an error in at least one code block, to cancel the transmission of remaining code blocks to the child node or the UE.

Thus, when there is an error detected in a CB (code block group (CBG) or TB) before the network node sends control information to the UE, the network node may cancel the scheduling of the TB to the UE.

According to an embodiment, the apparatus comprises means for requesting a re-transmission of the transport block or a subset of code blocks containing an error in at least one code block from the parent node.

The network node may indicate this to the parent node, e.g. using a HARQ-NACK (Hybrid Automatic Repeat reQuest Negative Acknowledgement) such that the parent node may send a retransmission. When a CBG level HARQ-ACK (Hybrid Automatic Repeat reQuest Acknowledgement) shall be adopted to make the scheme efficient, retransmission of the errored CBs is possible with CBG level HARQ.

According to an embodiment, the apparatus is configured, in response to detecting an error in at least one code block after sending control information about the subsets of code block to the child node or the UE, to transmit all remaining code blocks to the child node or the UE.

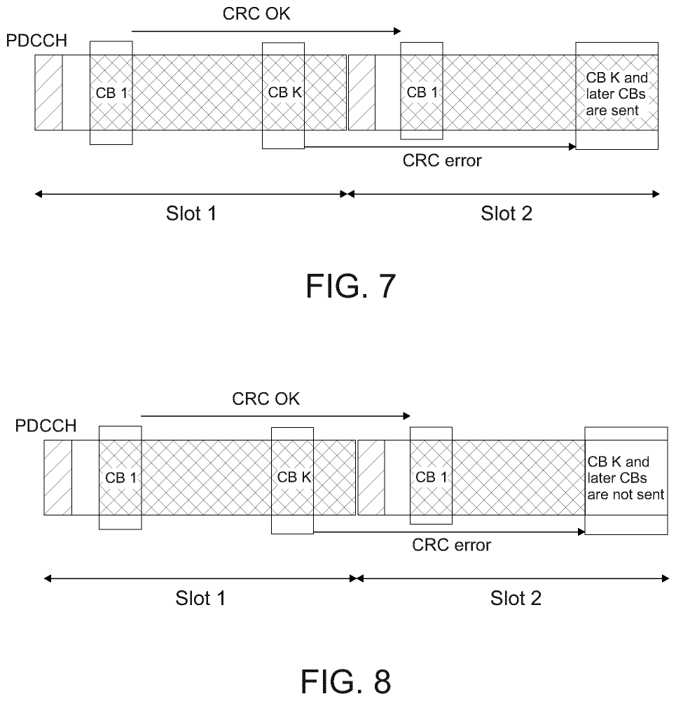

Thus, the network node may transmit all CBs even though the CRC of some later CBs (or CBGs) is failed. FIG. 7 shows an example, where the CRC of the CB K is found erroneous. However, the CB K and all subsequent CBs are nevertheless sent to child node or the UE.

According to an embodiment, the apparatus is configured to request a re-transmission of at least the code block containing an error; indicate the error to the child node or the UE; and re-transmit at least the code block previously containing an error after correctly receiving said code block from the parent node.

The network node may use e.g. HARQ-NACK to indicate to the parent node and request for the retransmission. The network node may also indicate the error CBs to the child node/the UE and reschedule the errored CBs once they are correctly received from the parent node. As above, the CBG level HARQ-ACK may also be adopted to make the scheme efficient. Retransmission of the errored CBs is then possible with CBG level HARQ.

According to an embodiment, the apparatus is configured, in response to detecting an error in at least one code block after sending control information about the subsets of code block to the child node or the UE, to seize to transmit any subsequent code blocks of the second transport block to the child node or the UE.

Hence, the network node may stop transmitting after a certain number of CBs, for example upon detecting an errored CB, whereupon the last part of the resources may be used for scheduling of some other UEs transmissions or blank errored CB transmissions. Thereby, the UE detects that no transmission is coming from the network node and does not waste energy on decoding the blank resources. Herein, similar HARQ procedure as described above may be used.

FIG. 8 shows an example, where the CRC of the CB K is found erroneous. Consequently, the CB K and all subsequent CBs are not transmitted to child node or the UE.

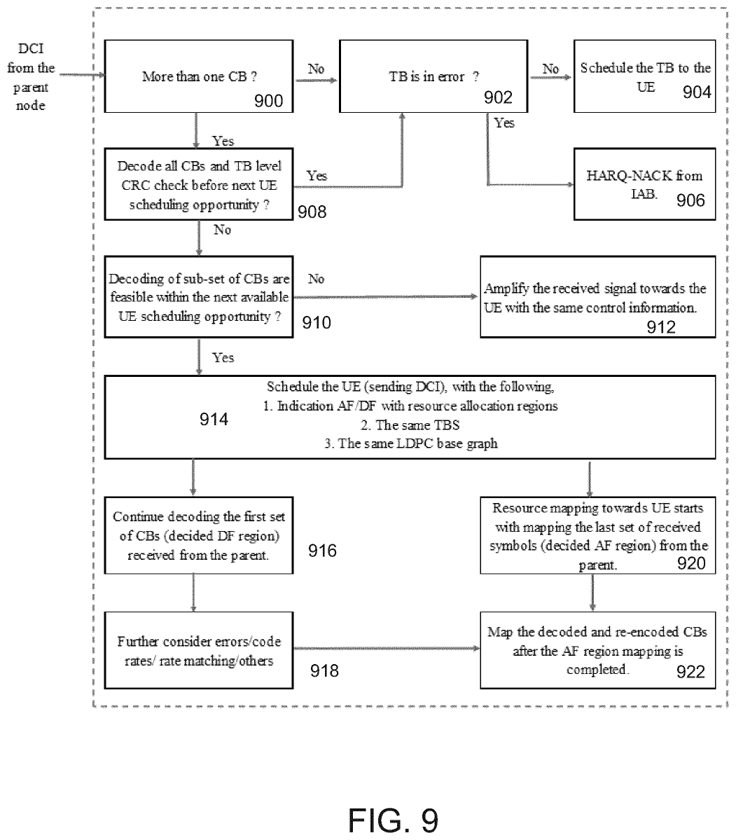

FIG. 9 shows a flow chart for a scheduling logic for a combined AF/DF approach according to some embodiments.

The network node receives the necessary control information, such as physical layer resource allocation, power control commands, HARQ information for both uplink and downlink, for example as DCI (Downlink Control Information), from the parent node. The network node checks (900) from the control information, whether the transport block (TB) comprises more than one code block (CB). If no, the network node performs (902) an error check for the TB, and based on the results, either schedules (904) the TB to be forwarded to the child node/UE or requests (906) a re-transmission from the parent node, e.g. via the HARQ-NACK procedure.

If the transport block (TB) comprises more than one code block (CB), the network node determines (908) whether it shall decode all CBs and perform the error check for the TB before the next scheduling opportunity. If yes, the above steps 902 and either of 904 or 906 will be carried out.

If no, the network node determines (910), for example based on the DCI, whether it is feasible to decode a subset of CBs within the next available scheduling opportunity. It is noted that determining the feasibility to decode the subset of CBs typically includes determining the feasibility to re-encode the subset of CBs and/or performing further processing for the subset of CBs. If the decoding of the subset of CBs within the next available scheduling opportunity is not feasible, the network node amplifies (912) the received signal and forwards it to the child node/UE with the received control information. In other words, the network node applies the amplify-and-forward (AF) approach for the whole TB.

If the decoding of the subset of CBs within the next available scheduling opportunity is feasible, the network node performs (914) the scheduling of the TB transmission to the child node/UE. This may involve including, for example in or along the DCI, one or more of following: indication of TB resource allocation between AF and DF regions, indication of the same transport block size (TBS) as in the received DCI, indication of the same base graph for low-density parity-check (LDPC) codes as in the received DCI.

Based on the TB resource allocation between AF and DF regions, the network node decodes (916) at least the first subset of CBs received from the parent node, whereafter the network node re-encodes the decoded CBs and possibly performs (918) further actions, such as re-determining error and/or code rates and/or rate matching. Based on the TB resource allocation between AF and DF regions, the network node also performs (920) the resource mapping of the TB such that the symbols from the CBs to be amplified (i.e. the subset of symbols received last in the TB from the parent node) are placed in the beginning of the TB to be forwarded to the child node/UE. Finally, the decoded and re-encoded CBs are mapped (922) to the end of the TB to be forwarded to the child node/UE.

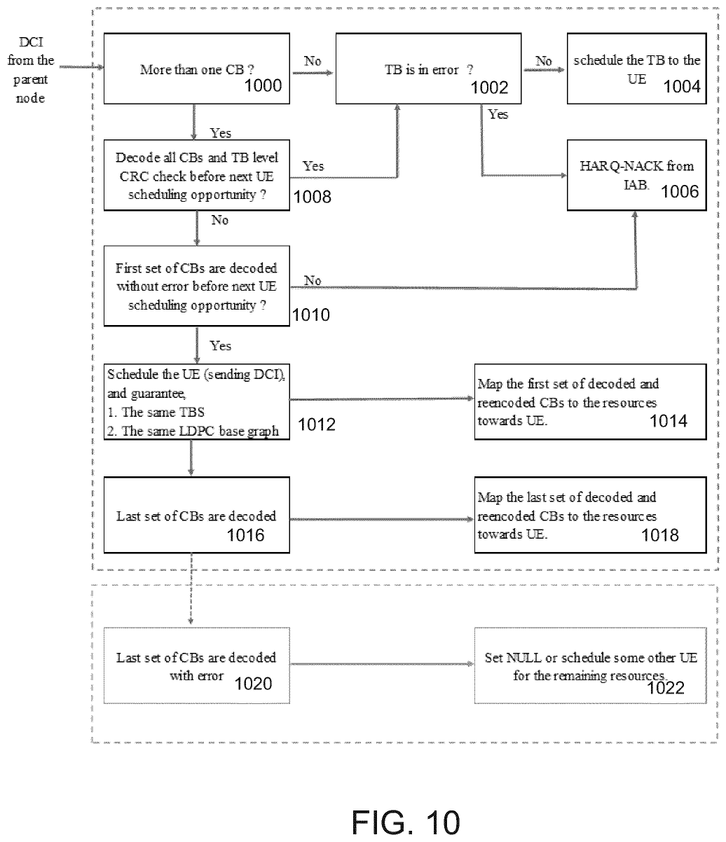

FIG. 10 shows a flow chart for a scheduling logic for a DF approach according to some embodiments.

The first steps are similar to the scheduling logic for the combined AF/DF approach: the network node receives the necessary control information, such as DCI, from the parent node. The network node checks (1000) from the control information, whether the transport block (TB) comprises more than one code block (CB). If no, the network node performs (1002) an error check for the TB, and based on the results, either schedules (1004) the TB to be forwarded to the child node/UE or requests (1006) a re-transmission from the parent node, e.g. via the HARQ-NACK procedure. If the transport block (TB) comprises more than one code block (CB), the network node determines (1008) whether it shall decode all CBs and perform the error check for the TB before the next scheduling opportunity. If yes, the above steps 1002 and either of 1004 or 1006 will be carried out.

If no, the network node decodes (1010) a first subset of CBs and performs an error check for the decoded CBs. If the error check reveals an error, the network node requests (1006) a re-transmission of the CBG or the whole TB from the parent node, e.g. via the HARQ-NACK procedure.

If the decoding of the first subset of CBs is non-erroneous, the network node performs (1012) the scheduling of the TB transmission to the child node/UE. This may involve including, for example in or along the DCI, one or more of following: indication of the same TBS as in the received DCI, indication of the same LDPC base graph as in the received DCI.

The network node decodes and re-encodes the first subset of CBs received from the parent node and maps (1014) the re-encoded subset of CBs to the TB to be forwarded to the child node/UE. The decoding (1016) and re-encoding process and mapping (1018) is continued until the last subset of CBs has been included in the TB to be forwarded to the child node/UE.

FIG. 10 further illustrates optional steps for the case that at least one of the subsequent CBs is erroneous. If the network node detects (1020) that a subsequent set of CBs is decoded with an error, the network node may configure (1022) the remaining resources of the TB to set as blank CB transmissions or used for scheduling of some other UEs transmissions.

The method and the embodiments related thereto may be implemented in an apparatus implementing a network node, such as an IAB node or a smart repeater. The apparatus may comprise at least one processor and at least one memory, said at least one memory stored with computer program code thereon, the at least one memory and the computer program code configured to, with the at least one processor, cause the apparatus at least to perform: receive a plurality of code blocks of a transport block arranged in a first time domain resource allocation from a parent node; decode at least a first subset of code blocks; and transmit at least the first subset of code blocks of the transport block at a second time domain resource allocation to a child node or a UE, wherein the number of code blocks in the first subset is determined at least based on a processing time for decoding the first set of code blocks or a latency target of the plurality of code blocks of a transport block or channel quality parameters of a link.

The method and the embodiments related thereto may likewise be implemented in an apparatus comprising means for implementing a first component configured to provide a backhaul connection to a parent node of a network; means for implementing a second component configured to provide a backhaul connection to a child node of a network and/or to an access link to a user equipment; means for receiving a plurality of code blocks of a transport block arranged in a first time domain resource allocation from the parent node; means for decoding at least a first subset of code blocks; and means for transmitting at least the first subset of code blocks of the transport block at a second time domain resource allocation to the child node or the user equipment, wherein the number of code blocks in the first subset is configured to be determined at least based on a processing time for decoding the first set of code blocks or a latency target of the plurality of code blocks of the transport block or channel quality parameters of the link.

Such apparatuses may comprise e.g. the functional units disclosed in any of the FIGS. 1 and 2 for implementing the embodiments.

According to an embodiment, the apparatus comprises means for amplifying at least a second subset of code blocks; and means for transmitting at least the amplified second subset of code blocks of the transport block at the second time domain resource allocation prior to the first subset of code blocks.

According to an embodiment, the apparatus comprises means for indicating an order of at least the first and the second subset of code blocks of the transport block at the second time domain resource allocation and the number of code blocks within the first and the second subset of code blocks to the child node or the UE.

According to an embodiment, the apparatus comprises means for dividing the plurality of code blocks of the transport block arranged in the first time domain resource allocation into a plurality of subsets of code blocks, wherein said means for decoding are configured to decode each of the subsets of code blocks, and wherein the subsets of code blocks are configured to be arranged at the second time domain resource allocation in the same temporal order as received in the first time domain resource allocation.

According to an embodiment, each subset of code blocks comprises only one code block.

According to an embodiment, the apparatus comprises means for performing error check for each code block after decoding.

According to an embodiment, the apparatus is configured, in response to detecting an error in at least one code block, to cancel the transmission of remaining code blocks to the child node or the UE.

According to an embodiment, the apparatus comprises means for requesting a re-transmission of the transport block or a subset of code blocks containing an error in at least one code block from the parent node.

According to an embodiment, the apparatus is configured, in response to detecting an error in at least one code block after sending control information about the subsets of code block to the child node or the UE, to transmit all remaining code blocks to the child node or the UE.

According to an embodiment, the apparatus is configured to request a re-transmission of at least the code block containing an error; indicate the error to the child node or the UE; and re-transmit at least the code block previously containing an error after correctly receiving said code block from the parent node.

According to an embodiment, the apparatus is configured, in response to detecting an error in at least one code block after sending control information about the subsets of code block to the child node or the UE, to seize to transmit any subsequent code blocks of the second transport block to the child node or the UE.

According to an embodiment, the apparatus is configured to receive, from the parent node, control information relating at least to size of the transport block and parameters enabling to perform amplifying and/or decoding of the code blocks.

According to an embodiment, the apparatus is configured to send the transport block to the child node or the UE as having the same size and comprising the same parameters as received from the parent node.

According to an embodiment, the apparatus comprises means for adjusting the number of code blocks to be included in the first subset of code block according to the processing capability of the apparatus.

In an exemplary embodiment, a computer program may be configured to cause a method in accordance with the embodiments described above and any combination thereof. In an exemplary embodiment, a computer program product, embodied on a non-transitory computer readable medium, may be configured to control a processor to perform a process comprising the embodiments described above and any combination thereof.

In an exemplary embodiment, an apparatus, such as an IAB node or a smart repeater, may comprise at least one processor, and at least one memory including computer program code, wherein the at least one memory and the computer program code are configured to, with the at least one processor, cause the apparatus at least to perform the embodiments described above and any combination thereof.

In general, the various embodiments of the invention may be implemented in hardware, circuitry or special purpose circuits or any combination thereof. While various aspects of the invention may be illustrated and described as block diagrams or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, such as UE or gNB, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Embodiments may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre stored design modules. Once the design for a semiconductor circuit has been completed, the resultant design, in a standardized electronic format (e.g., Opus, GDSII, or the like) may be transmitted to a semiconductor fabrication facility or “fab” for fabrication.

It is to be understood that the embodiments disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment. Thus, appearances of the phrases “in/according to one embodiment” or “in/according to an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and examples may be referred to herein along with alternatives for the various components thereof. It is understood that such embodiments, examples, and alternatives are not to be construed as de facto equivalents of one another, but are to be considered as separate and autonomous representations.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended examples. However, all such and similar modifications of the teachings of this invention will still fall within the scope of this invention.

1. An apparatus comprising:
at least one processor; and
at least one memory including computer program code, the at least one memory and the computer program code being configured to, with the at least one processor, cause the apparatus to
receive a plurality of code blocks of a transport block arranged in a first time domain resource allocation from a parent node;
decode at least a first subset of code blocks; and
transmit at least the first subset of code blocks of the transport block at a second time domain resource allocation to a child node or a user equipment, wherein the number of code blocks in the first subset is determined at least based on a processing time for decoding the first set of code blocks or a latency target of the plurality of code blocks of a transport block or channel quality parameters of a link.

2. The apparatus according to claim 1, wherein the apparatus is further caused to
amplify at least a second subset of code blocks; and
transmit at least the amplified second subset of code blocks of the transport block at the second time domain resource allocation prior to the first subset of code blocks.

3. The apparatus according to claim 2, wherein the apparatus is further caused to indicate an order of at least the first and the second subset of code blocks of the transport block at the second time domain resource allocation and the number of code blocks within the first and the second subset of code blocks to the child node or the user equipment.

4. The apparatus according to claim 1, wherein the apparatus is further caused to
divide the plurality of code blocks of the transport block arranged in the first time domain resource allocation into a plurality of subsets of code blocks;
decode each of the subsets of code blocks; and
arrange the subsets of code blocks at the second time domain resource allocation in the same temporal order as received in the first time domain resource allocation.

5. The apparatus according to claim 4, wherein each subset of code blocks comprises only one code block.

6. The apparatus according to claim 4, wherein the apparatus is further caused to
perform error check for each code block after decoding.

7. The apparatus according to claim 6, wherein the apparatus is configured, in response to detecting an error in at least one code block, to cancel the transmission of remaining code blocks to the child node or the user equipment.

8. The apparatus according to claim 7, wherein the apparatus is further caused to request a re-transmission of the transport block or a subset of code blocks containing an error in at least one code block from the parent node.

9. The apparatus according to claim 8, wherein the apparatus is further caused, in response to detecting an error in at least one code block after sending control information about the subsets of code block to the child node or the user equipment, to transmit all remaining code blocks to the child node or the user equipment.

10. The apparatus according to claim 9, wherein the apparatus is further caused to
request a re-transmission of at least the code block containing an error;
indicate the error to the child node or the user equipment; and
re-transmit at least the code block previously containing an error after correctly receiving said code block from the parent node.

11. The apparatus according to claim 7, wherein the apparatus is further caused, in response to detecting an error in at least one code block after sending control information about the subsets of code block to the child node or the user equipment, to seize to transmit any subsequent code blocks of the second transport block to the child node or the user equipment.

12. The apparatus according to claim 1, wherein the apparatus is further caused to receive, from the parent node, control information relating at least to size of the transport block and parameters enabling to perform amplifying and/or decoding of the code blocks.

13. The apparatus according to claim 12, wherein the apparatus is further caused to send the transport block to the child node or the user equipment as having the same size and comprising the same parameters as received from the parent node.

14. The apparatus according to claim 1, wherein the apparatus is further caused to adjust the number of code blocks to be included in the first subset of code block according to the processing capability of the apparatus.

15. The apparatus according to claim 1, wherein the apparatus comprises a repeater, a relay, a smart repeater, an Integrated Access and Backhaul node or a user equipment functioning as relay or a smart repeater.

16. The apparatus according to claim 1, wherein the child node comprises an Integrated Access and Backhaul node, a repeater or a user equipment.

17. (canceled)

18. A method comprising:
receiving a plurality of code blocks of a transport block arranged in a first time domain resource allocation from a parent node;
decoding at least a first subset of code blocks; and
transmitting at least the first subset of code blocks of the transport block at a second time domain resource allocation to a child node or a user equipment, wherein the number of code blocks in the first subset is determined at least based on a processing time for decoding the first set of code blocks or a latency target of the plurality of code blocks of a transport block or channel quality parameters of a link.

19. The method according to claim 18, comprising:
amplifying at least a second subset of code blocks; and
transmitting at least the amplified second subset of code blocks of the transport block at the second time domain resource allocation prior to the first subset of code blocks.

20. The method according to claim 19, comprising:
indicating an order of at least the first and the second subset of code blocks of the transport block at the second time domain resource allocation and the number of code blocks within the first and the second subset of code blocks to the child node or the user equipment.

21. The method according to claim 18, comprising:
dividing the plurality of code blocks of the transport block arranged in the first time domain resource allocation into a plurality of subsets of code blocks,
decoding each of the subsets of code blocks, and
arranging the subsets of code blocks at the second time domain resource allocation in the same temporal order as received in the first time domain resource allocation.

22. The method according to claim 21, wherein each subset of code blocks comprises only one code block.

23. The method according to claim 21, comprising:
performing error check for each code block after decoding.

24. The method according to claim 23, comprising:
cancelling, in response to detecting an error in at least one code block, the transmission of remaining code blocks to the child node or the user equipment.

25. The method according to claim 24, comprising:
requesting a re-transmission of the transport block or a subset of code blocks containing an error in at least one code block from the parent node.

26. The method according to claim 25, comprising:
transmitting, in response to detecting an error in at least one code block after sending control information about the subsets of code block to the child node or the user equipment, all remaining code blocks to the child node or the user equipment.

27. The method according to claim 26, comprising:
requesting a re-transmission of at least the code block containing an error;
indicating the error to the child node or the user equipment; and
re-transmitting at least the code block previously containing an error after correctly receiving said code block from the parent node.

28. The method according to claim 24, comprising:
seizing, in response to detecting an error in at least one code block after sending control information about the subsets of code block to the child node or the user equipment, to transmit any subsequent code blocks of the second transport block to the child node or the user equipment.

29. The method according to claim 18, comprising:
receiving, from the parent node, control information relating at least to size of the transport block and parameters enabling to perform amplifying and/or decoding of the code blocks.

30. The method according to claim 29, comprising:
sending the transport block to the child node or the user equipment as having the same size and comprising the same parameters as received from the parent node.

31. The method according to claim 18, comprising:
adjusting the number of code blocks to be included in the first subset of code block according to the processing capability of the apparatus.

32.-45. (canceled)
